(19) United States
(12) Patent Application Publication
(10) Pub. No.: US 2026/0267266 A1
(43) Pub. Date: Sep. 10, 2026

(54) IMAGE FORMING APPARATUS

(71) Applicant: CANON KABUSHIKI KAISHA, Tokyo (JP)

(72) Inventors: KOJI AN, Saitama (JP); KEISUKE ISHIZUMI, Kanagawa (JP); AI SUZUKI, Singapore (SG)

(21) Appl. No.: 19/551,507

(22) Filed: Feb. 26, 2026

(30) Foreign Application Priority Data
Mar. 6, 2025 (JP) 2025-035173

(51) Int. Cl. G03G 15/00; G03G 15/16

(52) U.S. Cl. CPC G03G 15/5004; G03G 15/161; G03G 15/80; G03G 2215/00978

(57) ABSTRACT

An apparatus including a developing unit that forms a toner image on a photosensitive drum, a transfer member to which the toner image is transferred, a power supply that supplies a current to the transfer member, a current detector that detects a current value, an information detector that acquires a moisture amount based on temperature and humidity, and a controller, in which the information detector acquires a first and a second moisture amount at a first and a second timing, the current detector detects a first current value and a second current value at the first timing and the second timing, and the controller controls a transfer condition in an operation based on the first and second moisture amounts and the first and second current values.

### BACKGROUND

### Field of the Technology

The aspect of the embodiment relates to an image forming apparatus.

### Description of the Related Art

In the related art, a configuration using an intermediate transfer member in an electrophotographic image forming apparatus such as a copying machine or a printer has been known. In such an image forming apparatus, an electrostatic latent image formed on a photosensitive drum as an image carrier is developed into a toner image by a developing device. Then, in a primary transfer step, the toner image on the photosensitive drum is transferred onto an intermediate transfer belt by applying a voltage from a voltage power supply to the primary transfer member disposed to face the photosensitive drum. In a full-color printer that forms a color image including a plurality of colors, this primary transfer step is executed for each color to superimpose toner images of the respective colors on each other, thereby forming a toner image including a plurality of colors on the surface of the intermediate transfer belt. Then, in a secondary transfer step, a voltage is applied to a secondary transfer member to transfer the toner images of a plurality of colors formed on the surface of the intermediate transfer belt to a surface of a recording material such as paper. The toner image transferred to the recording material is fixed by a fixing unit.

In the image forming apparatus of the intermediate transfer system as described above, when the intermediate transfer belt is replaced by a service engineer or the like, a CPU of the apparatus is not able to identify the characteristics of the replaced intermediate transfer belt. Therefore, various conditions such as various voltage values such as the primary transfer voltage and the secondary transfer voltage are not able to be set to optimum values according to the characteristics of the replaced intermediate transfer belt. The characteristics of the intermediate transfer belt include electrical characteristics (volume resistance, surface resistance, electrostatic capacitance, and the like), mechanical characteristics (thickness, hardness, elongation, and the like), physical characteristics (color, surface roughness, and the like), and the like.

In regard to this issue, Japanese Patent Laid-Open H10-268663 makes it possible to identify the characteristics of the intermediate transfer belt according to the number of detection holes by detecting a plurality of detection holes for identification provided in a non-transfer region of the intermediate transfer belt by a detection sensor.

However, in a detection method of Japanese Patent Laid-Open H10-268663, since the detection hole is provided in a non-transfer region of the intermediate transfer belt, the strength is lowered, and there is a possibility that the conveyability of the recording material is lowered by long-term use.

### SUMMARY

An apparatus capable of executing an operation of forming an image on a recording material, the apparatus comprising: a photosensitive drum; a developing unit that forms a toner image by supplying toner to the electrostatic latent image formed on a surface of the photosensitive drum; a transfer member to which the toner image is transferred from the photosensitive drum; a power supply unit that supplies a current to the transfer member; a detection unit that detects a current value supplied by the power supply unit; an information detection unit that acquires information on a moisture amount in an environment in which the apparatus is installed, based on information on temperature and humidity in the environment; and a control unit; wherein the information detection unit acquires a first moisture amount at a first timing and acquires a second moisture amount at a second timing, the current detection unit detects a first current value at the first timing and detects a second current value at the second timing, and the control unit controls a transfer condition in the forming operation based on the first moisture amount, the second moisture amount, the first current value, and the second current value.

Features of the disclosure will become apparent from the following description of embodiments with reference to the attached drawings. The following description of embodiments is described by way of example.

### BRIEF DESCRIPTION OF THE DRAWINGS

FIGS. 1A and 1B are diagrams for illustrating an operation of a discharge control according to a first embodiment.

FIG. 2 is a sectional view for illustrating the image forming apparatus having characteristics of the first embodiment.

FIG. 3 is a diagram for illustrating control of an image forming process according to the first embodiment.

FIG. 4 is a diagram for illustrating control of weak exposure of the image forming process according to the first embodiment.

FIG. 5 is a diagram for illustrating an outline of a periphery of a primary transfer power supply.

FIG. 6 is a flowchart illustrating control according to the first embodiment.

FIG. 7 is a sectional view illustrating an image forming apparatus having another configuration.

FIG. 8 is a diagram for illustrating cleaning control in another configuration.

FIG. 9 is a sectional view illustrating an image forming apparatus in another configuration.

FIGS. 10A and 10B are diagrams for illustrating an operation of control according to a second embodiment.

### DESCRIPTION OF THE EMBODIMENTS

Hereinafter, embodiments of the disclosure will be described in detail with reference to the drawings. However, the dimensions, materials, shapes, relative arrangements, and the like of the components described in the following embodiments should be appropriately changed according to the configuration of the apparatus to which the disclosure is applied and various conditions. Therefore, the scope of the disclosure is not limited unless otherwise specified. Although a plurality of features are described in the embodiments, all of the plurality of features are not necessarily essential to the disclosure, and the plurality of features may be arbitrarily combined.

### First Embodiment

### <Description of Image Forming Apparatus>

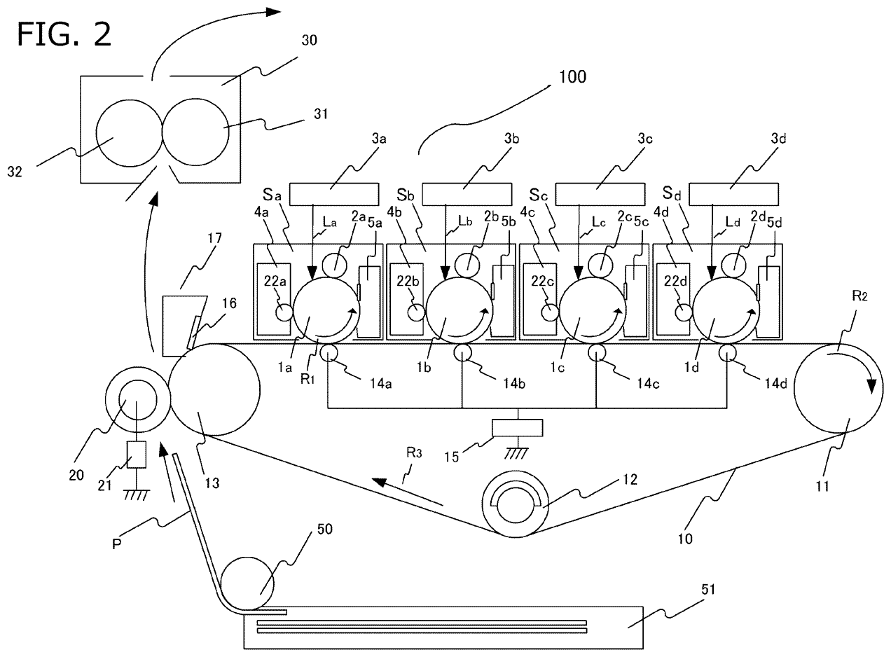

First, an overall configuration of an electrophotographic image forming apparatus (hereinafter, referred to as an image forming apparatus) will be described. FIG. 2 is a schematic sectional view of an image forming apparatus 100 of the embodiment. Hereinafter, the configuration, operation, and control of the image forming apparatus 100 will be described with reference to FIG. 2. The image forming apparatus 100 of the embodiment is a full-color laser printer adopting an in-line method and an intermediate transfer method.

The image forming apparatus 100 forms a full-color image on a recording material P (for example, a recording sheet or a plastic sheet) according to image information. The image information is input to the image forming apparatus 100 from an image reading apparatus included in the image forming apparatus 100 or connected to the image forming apparatus 100, or a host computer such as a personal computer communicably connected to the image forming apparatus 100.

The image forming apparatus 100 includes, as a plurality of image forming units, first, second, third, and fourth process cartridges Sa, Sb, Sc, and Sd for forming images of respective colors of yellow (Y), magenta (M), cyan (C), and black (K), respectively. In the embodiment, the first to fourth process cartridges Sa, Sb, Sc, and Sd are arranged in a line in a direction intersecting the vertical direction. In the embodiment, the configurations and operations of the first to fourth process cartridges Sa, Sb, Sc, and Sd are substantially the same except that colors of images to be formed are different. Therefore, in the following, when no particular distinction is required, subscripts a, b, c, and d representing elements provided for any color will be omitted and collectively described.

In the embodiment, the image forming apparatus 100 includes, as a plurality of image carriers, four drum-type electrophotographic photosensitive members arranged side by side in a direction intersecting the vertical direction, that is, a photosensitive drum 1 (1a, 1b, 1c, 1d).

The photosensitive drum 1 is rotationally driven by a driving unit (driving source) (not illustrated). A charging roller 2 (2a, 2b, 2c, 2d), a scanner unit (exposure device) 3 (3a, 3b, 3c, 3d), and a developing unit (developing device) 4 (4a, 4b, 4c, 4d) are disposed around the photosensitive drum 1.

The charging roller 2 is a charging unit that uniformly charges a surface of the photosensitive drum 1. A scanner unit 3 is an exposure unit that forms an electrostatic image (electrostatic latent image) on the photosensitive drum 1 by emitting laser based on an output calculated by the CPU 150 from image information input from a host computer. When an electrostatic latent image according to an image signal is formed by the exposure unit, a non-image portion region of the surface of the photosensitive drum 1 is uniformly and weakly exposed to stabilize the potential of the photosensitive drum. Hereinafter, formation of an electrostatic image by an exposure unit is referred to as “exposure”, and uniform exposure of the non-image portion region is referred to as “weak exposure” for distinction.

A developing unit 4 is a developing unit that develops an electrostatic image as a developer (toner) image. The developing unit 4 supplies the toner contained in a container to the photosensitive drum 1 using a developing roller 22 or the like. A cleaning device 5 is a cleaning unit that removes toner (transfer residual toner) remaining on the surface of the photosensitive drum 1 after the primary transfer. The photosensitive drum 1, the charging roller 2 as a process unit acting on the photosensitive drum 1, and the developing unit 4 are integrated to form a process cartridge S. The process cartridge S is attachable to and detachable from the image forming apparatus 100 via an attachment unit such as an attachment guide and a positioning member provided in the image forming apparatus 100.

A charging voltage Vpri applied to the charging roller 2 during the image formation of the embodiment is −1200 V, and the drum potential after charging is approximately −700 V. A drum potential after weak exposure formed in the non-image region by weak exposure is approximately −500 V. The developing voltage applied to the developing roller 22 is −300 V, and an exposure portion drum potential at which the charge is attenuated by the exposure is approximately −150 V. Due to the potential difference between a developing roller voltage and an exposure portion drum potential, the electrostatic latent image is visualized at the developing unit where the negatively charged toner comes into contact with the photosensitive drum 1 to form a toner image.

Note that the toner on the developing roller 22 is electrically held so as not to be transferred to the non-image portion region due to the potential difference between the developing voltage and the drum potential after weak exposure formed by weak exposure. In the embodiment, the normal charging polarity of the toner is set to a negative polarity, and the polarity opposite to the normal charging polarity is set to a positive polarity, but the disclosure is not limited thereto.

In the image forming apparatus 100, an intermediate transfer belt 10 as an intermediate transfer member is disposed so as to face the four photosensitive drums 1. The intermediate transfer belt 10 is an intermediate transfer member that transfers the toner image on the photosensitive drum 1 to the recording material P. The intermediate transfer belt 10 formed of an endless belt comes into contact with all the photosensitive drums 1 and circulates (rotates) in a direction of an arrow R3 (clockwise direction in the drawing). The intermediate transfer belt 10 is stretched around a driving roller 11, a stretching roller 12, and a secondary transfer opposite roller 13 as a plurality of support members.

On the inner peripheral surface side of the intermediate transfer belt 10, four primary transfer rollers 14 (14a, 14b, 14c, 14d) as primary transfer units are arranged to face the respective photosensitive drums 1. The primary transfer roller 14 presses the intermediate transfer belt 10 toward the photosensitive drum 1 to form a primary transfer unit where the intermediate transfer belt 10 and the photosensitive drum 1 abut on each other.

A voltage (+300 V in the embodiment) having a polarity opposite to the normal charging polarity of the toner is applied to the primary transfer roller 14 from a primary transfer power supply 15 as a primary transfer voltage applying unit. As the primary transfer power supply 15, a power supply unit such as a high-voltage power supply included in the apparatus can be used. The toner image on the photosensitive drum 1 is primarily transferred onto the intermediate transfer belt 10 by a potential difference between the exposure portion drum potential and the primary transfer voltage. At the time of forming a full-color image, the above-described primary transfer process is sequentially performed in the first to fourth process cartridges Sa, Sb, Sc, and Sd, and the toner images of the respective colors are superimposed on the intermediate transfer belt 10. The primary transfer roller 14 is a cylindrical metal roller of φ 6 mm, and is made of a nickel-plated SUS material.

A secondary transfer roller 20 as a secondary transfer unit is disposed at a position facing the secondary transfer opposite roller 13 on the outer peripheral surface side of the intermediate transfer belt 10. The secondary transfer roller 20 is pressed against the secondary transfer opposite roller 13 via the intermediate transfer belt 10 to form a secondary transfer unit where the intermediate transfer belt 10 and the secondary transfer roller 20 abut against each other. A voltage having a polarity opposite to the normal charging polarity of the toner is applied to the secondary transfer roller 20 from a secondary transfer power supply 21 (high-voltage power supply) as a secondary transfer voltage applying unit. As a result, the four-color toner images on the intermediate transfer belt 10 are secondarily transferred collectively onto the recording material P by the action of the secondary transfer roller 20 in contact with the intermediate transfer belt 10 via the recording material P.

Note that the recording material P stored in a cassette 51 is conveyed to the secondary transfer unit by a feeding unit 50 in synchronization with the movement of the intermediate transfer belt 10.

In the secondary transfer opposite roller 13, the secondary transfer residual toner remaining on the intermediate transfer belt 10 is cleaned and removed by the cleaning device 16 via the intermediate transfer belt 10, and stored in a waste toner storage container 17.

After completion of the secondary transfer, the recording material P carrying the toner images of four colors is conveyed to a fixing device 30. In the fixing device 30, a fixing roller 31 and a pressure roller 32 form a fixing nip portion. By heating and pressurizing at the fixing nip portion, the toners of the four colors are melted and mixed to be fixed to the recording material P. The recording material P is then discharged from the image forming apparatus 100.

Note that the image forming apparatus 100 can also form a monochromatic or multicolor image using one desired image forming unit or using some (not all) image forming units. In the embodiment, the image forming apparatus 100 is a printer compatible with LETTER sized paper with a process speed of 184 mm/sec.

### <Control Configuration>

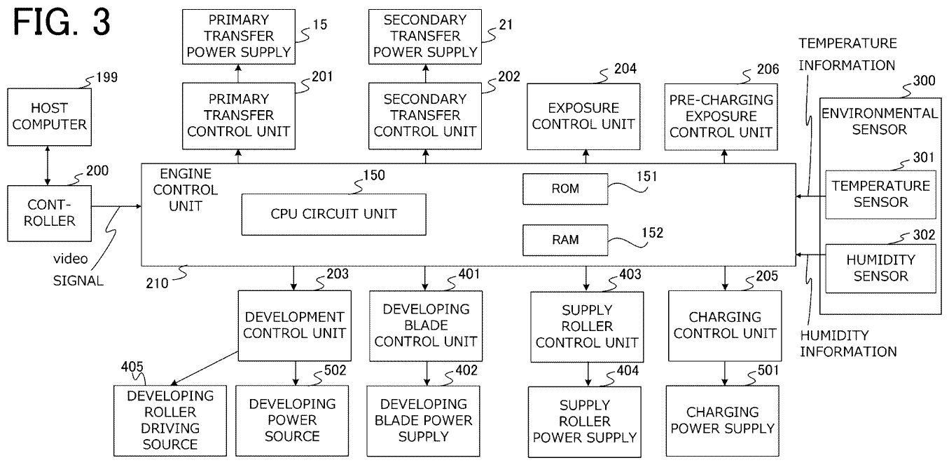

A configuration of an engine control unit 210 that controls the entire image forming apparatus will be described with reference to FIG. 3. The engine control unit 210 incorporates a CPU 150, a ROM 151, and a RAM 152 as storage units that store information and tables. The CPU 150 integrally controls a primary transfer control unit 201, a secondary transfer control unit 202, a development control unit 203, an exposure control unit 204, a charging control unit 205, and a pre-charging exposure control unit 206 according to a control program stored in the ROM 151.

The RAM 152 temporarily holds control data and is used as a work area for arithmetic processing associated with control. When receiving the print information and the print command from a host computer 199, a controller 200 can execute an image forming operation necessary for a print operation by controlling each control unit (primary transfer control unit 201, secondary transfer control unit 202, development control unit 203, exposure control unit 204, charging control unit 205, and pre-charging exposure control unit 206).

An environmental sensor 300 is an environment information detection unit that acquires environment information (here, temperature and humidity) of the image forming apparatus 100. The environmental sensor 300 is connected to the image forming apparatus 100 and includes a temperature sensor 301 that detects an environmental temperature and a humidity sensor 302 that detects an environmental humidity. A CPU 150 of the engine control unit 210 calculates the absolute moisture amount in the image forming apparatus 100 based on the detection results of the temperature sensor 301 and the humidity sensor 302. The temperature sensor 301 and the humidity sensor 302 to which the function of calculating the absolute moisture amount of the CPU 150 is added can also be considered as an environment information detection unit.

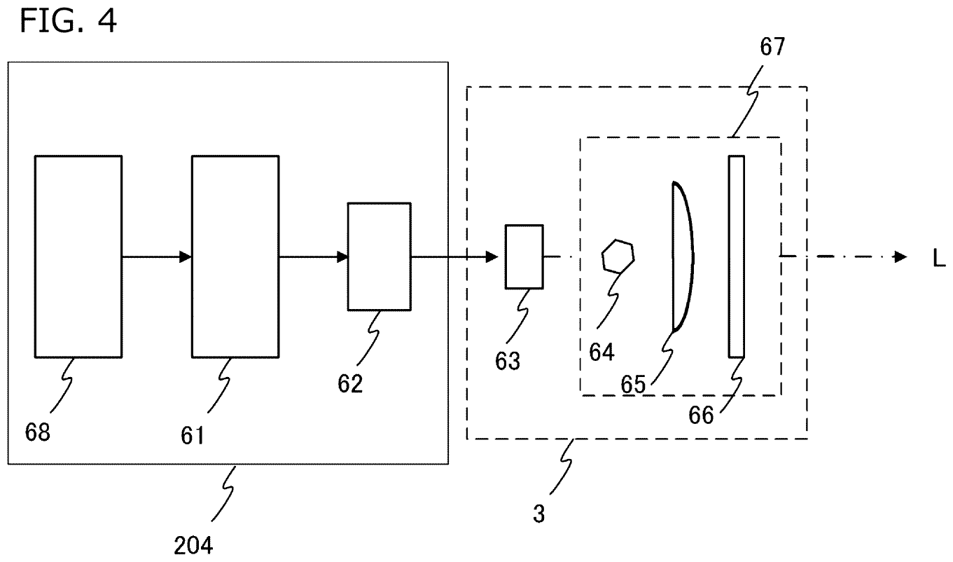

Control of weak exposure of the non-image portion region performed in the embodiment will be described with reference to FIG. 4. In FIG. 4, an image signal (Video signal) transmitted from the controller 200 to the engine control unit 210 is a multi-value signal (0 to 255) having a depth direction of 8 bits=256 gradations. When the value of the image signal is 0, the laser beam is turned off, when the value is 255, the laser beam is completely turned on, and when the value is 1 to 254, the laser beam has an intermediate value between the two.

Here, a level of the non-image portion exposure can be optionally set according to the level of the multi-level signal. In the following description, it is assumed that the non-image portion exposure is performed using 32 as the level of the multi-level signal. Therefore, the non-image portion in which the image signal transmitted from the controller 200 is 0 is converted into 32 by an image signal conversion circuit 68 in the exposure control unit 204, and the image signal having a value of 1 to 255 is compressed and converted into 255 from 33.

The converted signal is converted into a serial signal in a time axis direction by a frequency modulation circuit 61. In embodiment, it is used for pulse width modulation of each dot pulse having a resolution of 600 dots/inch.

A laser driver 62 is driven by the converted signal, a laser diode 63 of the scanner unit 3 emits light, and a laser beam L is emitted. The laser beam L passes through a correction optical system 67 including a polygon mirror 64, a lens 65, and a folding mirror 66, and is emitted to the photosensitive drum 1 as scanning light. The frequency modulation circuit 61 may be provided on the controller side away from the laser driver 62.

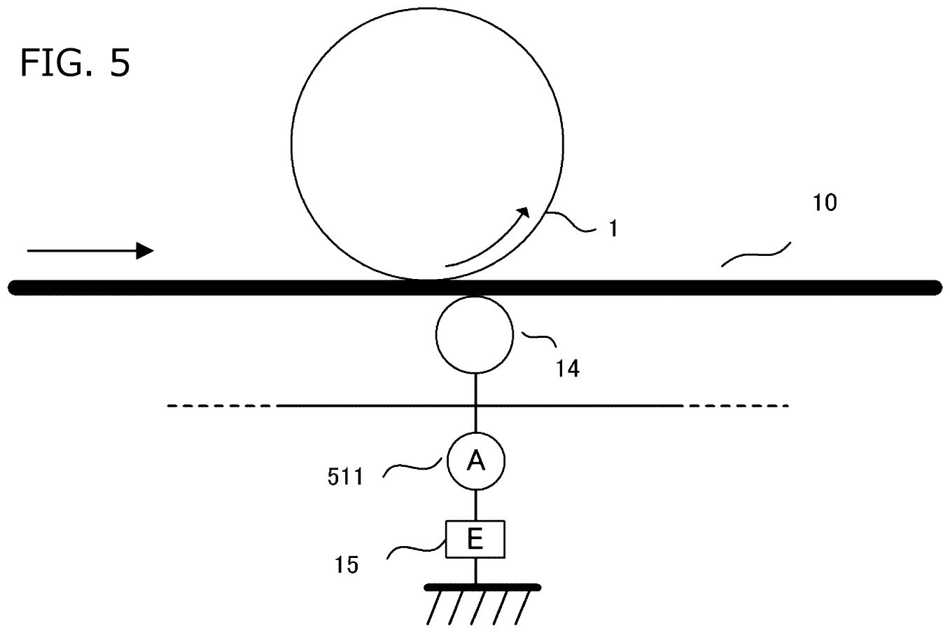

FIG. 5 illustrates a schematic diagram of a power supply circuit around a process cartridge. The primary transfer power supply 15 and a current detection circuit 511 as a current detector are connected to the primary transfer control unit 201. The current detection circuit 511 detects a primary transfer current value (hereinafter, the primary transfer current value is also simply referred to as a “current value” unless otherwise specified) flowing from the primary transfer roller 14 to the photosensitive drum 1 via the intermediate transfer belt 10. In the embodiment, the current detection circuit 511 is connected to the primary transfer power supply 15 and the primary transfer roller 14. Although the current flowing through the four process cartridges is detected in the embodiment, the disclosure is not limited thereto, and the current flowing through one or more process cartridges may be detected.

### <Features>

According to the disclosure, characteristics of intermediate transfer belt 10 can be determined. At that time, the control unit detects a difference in various parameters according to the characteristics based on the detection information. Then, by detecting the various parameters, as a result, electrical (ionic or electronic) characteristics can be distinguished. Typically, the control unit detects changes in various current values with respect to changes in temperature and humidity of the environment. Furthermore, the characteristics of the intermediate transfer belt 10 are determined based on the detection results, and various types of control can be optimized in accordance with the characteristics. The optimization of various types of control is, for example, changing transfer conditions (typically, voltage values of various transfer voltages such as a primary transfer voltage and a secondary transfer voltage) according to the characteristics.

One of two types of belts having different electrical characteristics, to be installed, will be described as an intermediate transfer belt 10 in the embodiment. The two types of belts are a belt exhibiting electronic conductivity electrical characteristics and a belt exhibiting ion conductivity electrical characteristics. The intermediate transfer belt 10 having electronic conductivity has a characteristic that the variation of the resistance value with respect to the temperature and humidity of the atmosphere is small. On the other hand, the intermediate transfer belt 10 having ion conductivity has a characteristic that the variation of the resistance value with respect to the temperature and humidity of the atmosphere is large.

First, the intermediate transfer belt 10 used in the embodiment will be described in detail, and thereafter, units for detecting the electrical characteristics of the intermediate transfer belt 10 will be described. Hereinafter, the intermediate transfer belt 10 exhibiting electronic conductivity is referred to as an electronic belt 10E, and the intermediate transfer belt 10 exhibiting ionic conductivity is referred to as an ionic belt 10I. In a case where both are common, the intermediate transfer belt 10 is simply used without distinction.

### <Feature: Intermediate Transfer Belt 10>

In the embodiment, the intermediate transfer belt 10 is an endless belt using a polyimide resin having a circumferential length of 695 mm and a thickness of 90 km. In the embodiment, carbon is mixed as a conductive agent in the electronic belt 10E. In the ionic belt 10I, a low molecular weight ion conductive agent such as various metal salts and glycols is mixed. As the conductive agent of the electronic belt 10E, conductive metal oxide fine particles can be used in addition to carbon. The conductive agent of the ionic belt 10I may be an ionic conductive agent having an ether bond, or an ionic conductive agent such as a polyvalent metal salt or a quaternary ammonium salt in addition to a low molecular weight ionic conductive agent such as various metal salts or glycols.

In the embodiment, a polyimide resin is used as the material of the intermediate transfer belt 10, but the material is not limited thereto. As a material of the intermediate transfer belt 10, for example, a thermoplastic resin including the following materials can be suitably used. For example, resins such as polyimide, polyester, polyethylene terephthalate (PET), polybutylene terephthalate (PBT), polycarbonate, polyarylate, an acrylonitrile-butadiene-styrene copolymer (ABS), polyphenylene sulfide (PPS), and polyvinylidene fluoride (PVdF), and mixed resins thereof can be used.

In the embodiment, the volume resistivity of the intermediate transfer belt 10 is 1×10⁹ Ω·cm. The volume resistivity was measured using HIRESTA-UP (MCP-HT450) manufactured by Mitsubishi Chemical Corporation as ring probe type UR (model: MCP-HTP12). The measurement was performed under the conditions of an applied voltage of 100 V and a measurement time of 10 sec with the indoor temperature set to 23° C. and the indoor humidity set to 50%. Here, the volume resistivity is a measure of conductivity as a material of the intermediate transfer belt 10.

Here, the intermediate transfer belt 10 may have a single-layer configuration or a multilayer configuration including a plurality of layers. The intermediate transfer belt 10 having the multilayer configuration may have, for example, the following configuration. First, the thickest layer among the layers constituting the intermediate transfer belt 10 in the thickness direction of the intermediate transfer belt 10 is set as a base layer. At this time, the thermoplastic resin described above can be suitably used as the base layer. A surface layer of a high-resistance acrylic resin having a thickness of about 0.5 to 3 m is provided on an outer surface of the base layer. The high resistance layer of the surface layer is provided, for example, for improving secondary transferability.

Further, an inner surface layer formed on the inner peripheral surface side of the intermediate transfer belt 10 is provided. The electric resistances of the base layer and the inner surface layer may be different from each other, and the potential of the surface of the intermediate transfer belt can be stabilized by setting the electric resistance of the inner surface layer to be lower than that of the base layer. As a material of the inner surface layer, an acrylic resin can be used, but other materials may be used, and for example, a material such as polyester may be used. Here, the surface resistivity measured from the outer peripheral surface side (base layer side) can be taken as the electric resistance of the base layer, and the surface resistivity measured from the inner peripheral surface side (inner surface layer side) can be taken as the electric resistance of the inner surface layer.

### <Feature: Method for Detecting Electrical Characteristics of Intermediate Transfer Belt 10>

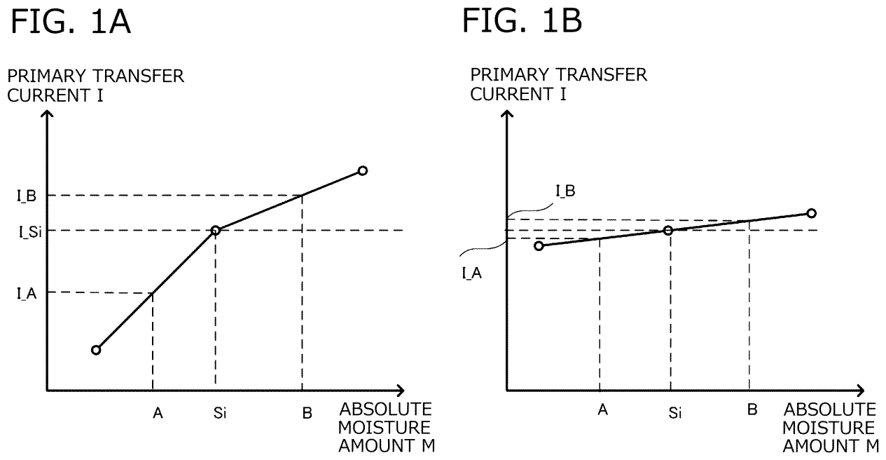

A unit for detecting the electrical characteristics of intermediate transfer belt 10, which is a feature of the disclosure, will be described. As described with reference to FIG. 5, the current flowing from the primary transfer roller 14 to the photosensitive drum 1 via the intermediate transfer belt 10 can be detected by the current detection circuit 511. In the embodiment, a current value flowing between the non-image portion photosensitive drum potential of −500 V when the image forming operation is started and +300 V applied to the primary transfer power supply 15 is detected. FIGS. 1A and 1B are graphs obtained by plotting a detected current value with respect to an absolute moisture amount detected by the environmental sensor 300. FIG. 1A illustrates a case of the ionic belt 10I, and FIG. 1B illustrates a case of the electronic belt 10E.

Here, at an absolute moisture amount of 8.9 g/m³ at a temperature of 23° C. and a humidity of 50%, the volume resistances of both belts are the same, so that the current values are also substantially the same (I_Si for absolute moisture amount Si). In the case of the electronic belt 10E, since the resistance value fluctuates little with respect to the change in the temperature and humidity of the environment, the change in the current value is also small with respect to the change in the absolute moisture amount as illustrated in FIG. 1B. For example, the difference between a primary transfer current I_A at an absolute moisture amount A and a primary transfer current I_B at an absolute moisture amount B is relatively small.

On the other hand, in the case of the ionic belt 10I, since the change in the resistance value is large with respect to the change in the temperature and humidity of the environment, the current value with respect to the change in the absolute moisture amount changes. Specifically, as illustrated in FIG. 1A, as the absolute moisture amount of the environment increases, the current easily flows. In other words, the difference between the primary transfer current I_A and the primary transfer current I_B is relatively large. This is because, in the ionic belt 10I, the ions contained in the intermediate transfer belt 10 are carriers of charges, and the ions (carriers) increase and the resistance value decreases by containing a large amount of moisture. Conversely, when the absolute moisture amount decreases, the resistance value increases and the current hardly flows.

In the embodiment, the characteristics of the intermediate transfer belt 10 are determined from the difference in the electrical characteristics with respect to the change in temperature and humidity of the environment of the intermediate transfer belt 10. Specifically, the current value is measured at two timings with different detected absolute moisture amounts. From each current value and the absolute moisture amount, a change rate ΔI of the current value with respect to the change in the absolute moisture amount is calculated as in Equation (1).

$$Δ I = ( {I}_{B} - {I}_{A} ) / ( B - A ) \qquad ( Equation 1 )$$

In the above Equation, A and B are each an absolute moisture amount detected by the image forming apparatus 100, and A≠B [g/m³] (that is, an absolute moisture amount at another timing). I_{A} is a current value [μA] at an absolute moisture amount A [g/m³], and I_{B} is a current value [μA] at an absolute moisture amount B [g/m³]. ΔI is the ratio of the change in the current value to the change in the absolute moisture amount, and the unit is [μA/g/m³]. When ΔI is negative, it is considered as an absolute value.

Threshold values X and Y (<X) for ΔI are stored in the RAM 152 in advance. Here, if ΔI obtained earlier is X or more, since the current value change with respect to the change in the absolute moisture amount is large, it can be determined that the intermediate transfer belt 10 installed in the image forming apparatus 100 is the ionic belt 10I. On the other hand, if ΔI is less than Y, the current value change with respect to the change in the absolute moisture amount is small, so that it can be determined that the intermediate transfer belt 10 installed in the image forming apparatus 100 is the electronic belt 10E.

In the embodiment, two threshold values are set in order to reliably determine the belt characteristic, and an intermediate region of Y<ΔI<X is provided. That is, when the change in ΔI as the detection result is moderate, the electrical characteristics of the intermediate transfer belt 10 are not determined. This prevents erroneous detection of the electrical characteristics of the intermediate transfer belt 10. In the embodiment, the threshold values X and Y are set to X=0.3 μA/g/m³ and Y=0.05 μA/g/m³, respectively.

When the absolute moisture amounts A and B are too close to each other, ΔI may increase to cause erroneous detection. Therefore, in one embodiment, when A and B are different to some extent (about 2.0 g/m³ or more), ΔI is calculated.

After the electrical characteristics of the intermediate transfer belt 10 are detected as described above, transfer control is performed in accordance with the characteristics. That is, the transfer control is performed as follows according to the value of ΔI.
(Case 1) When ΔI>X, use of control table for ionic belt
(Case 2) When ΔI<Y, use of control table for electronic belt
(Case 3) When Y≤ΔI≤X, belt characteristics are not able to be determined, and therefore a moderate control table is used.

As described above, in the case of (Case 3) Y≤ΔI≤X, a moderate control table is used so as not to cause erroneous detection in the determination of the electrical characteristics of the belt. In this case, ΔI may be calculated again (for example, after a predetermined time has elapsed), and the characteristics of the intermediate transfer belt 10 may be detected again. On the other hand, in the case of (Case 1) ΔI>X and the case of (Case 2) ΔI<Y, since the characteristics of the intermediate transfer belt 10 can be determined, the calculation of ΔI and the detection of the intermediate transfer belt characteristics need not be performed again.

The control table is determined in this order, and optimum control is performed by the image forming apparatus. As an example, Table 1 shows an example of control of the primary transfer voltage with respect to each absolute moisture amount.

TABLE 1

| Absolute moisture amount | 1.0 g/m³ | 8.9 g/m³ | 21.0 g/m³ |
|---|---|---|---|
| Ionic table | +450 V | +300 V | +200 V |
| Moderate table | +350 V | +300 V | +250 V |
| Electronic table | +300 V | +300 V | +300 V |

As described above, the resistance value of the ionic belt 10I fluctuates greatly with respect to a change in temperature and humidity of the environment. In other words, the resistance value decreases as the absolute moisture amount increases, and the resistance value increases as the absolute moisture amount decreases. Therefore, the optimum voltage changes in each environment. Therefore, as shown in Table 1, in the case of the ionic table, the primary transfer voltage is controlled to be high in an environment with a small absolute moisture amount, and the primary transfer voltage is controlled to be low in an environment with a large absolute moisture amount so that the primary transfer current value does not change significantly. On the other hand, in a case of an electronic table, since the resistance value fluctuates little with respect to the change in the absolute moisture amount, the control may be performed at the same primary transfer voltage regardless of the absolute moisture amount. When it is not possible to determine the electrical characteristics of the belt (Y<ΔI<X), control (in Table 1, described as a moderate table) between the ionic table and the electronic table is executed. In other words, in the control of Table 1, it can be said that the larger the current change rate of the intermediate transfer belt 10, the larger the degree of change in the applied voltage according to the change in the absolute moisture amount, and the smaller the current change rate, the smaller the degree of change in the applied voltage according to the change in the absolute moisture amount.

Note that, since the moderate table does not correspond to optimal control in accordance with the electrical characteristics of the intermediate transfer belt 10, in one embodiment, whether the table is the ionic table or the electronic table at an early stage is determined. Therefore, as the execution timing of the present control, for example, ΔI may be calculated from the current value and the absolute moisture amount at the time of the preparation operation before printing (hereinafter, referred to as a forward rotation operation) and the post-processing operation after printing (hereinafter, referred to as a backward rotation operation) when the consecutive printing operation is executed. Alternatively, when the user installs the image forming apparatus for the first time or when the service engineer replaces the intermediate transfer belt 10, as an initial operation at the time of installation, the fixing device 30 may be rotated while being heated, thereby forcibly changing the temperature and humidity inside the image forming apparatus greatly. By forcibly changing the absolute moisture amount in this manner, it is easy to determine the change in the current value.

In addition, for example, ΔI may be calculated by detecting the current value and the absolute moisture amount near the start of use (for example, timing at which the main body returns from the sleep state) and the end of use (for example, an appropriate timing before the main body enters the sleep state) of the main body, or during the day (for example, after a certain period of time from when the main body returns from the sleep state) and at night (for example, after a certain period of time from when the main body enters the sleep state) as the timing when the temperature and humidity greatly change.

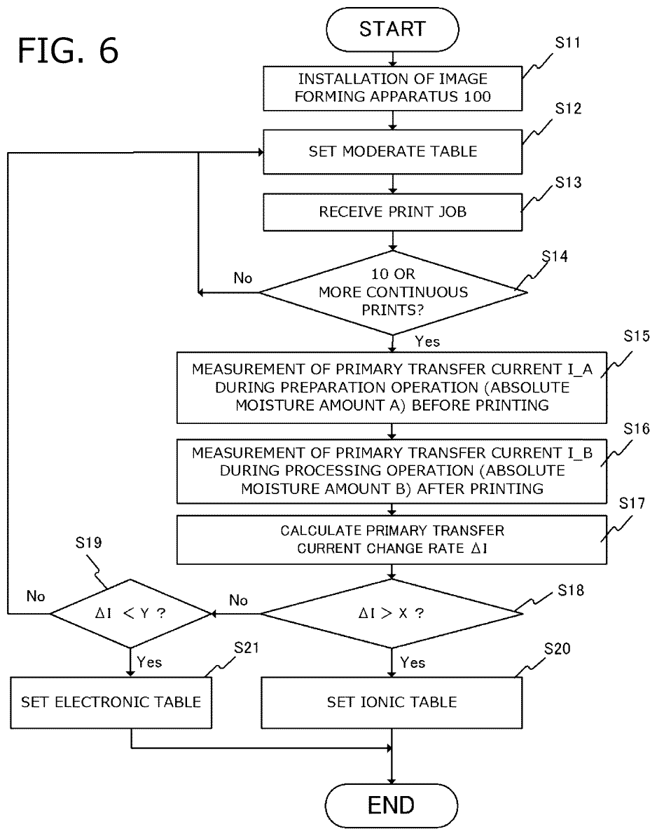

How to perform the operation of the embodiment and reflect the operation in the control when the user installs the image forming apparatus 100 for the first time among some examples described above will be described with reference to the flowchart illustrated in FIG. 6.

In the following flow, a part related to control is realized by controlling each component of the apparatus by various components related to control of the image forming apparatus 100. In addition to the engine control unit 210, components related to such control include a primary transfer control unit 201, a secondary transfer control unit 202, a development control unit 203, an exposure control unit 204, a charging control unit 205, and a pre-charging exposure control unit 206. Therefore, hereinafter, these configurations related to the control will be collectively referred to as a control unit, and the description will be given assuming that the execution subject of each step is the control unit.

First, the image forming apparatus 100 is installed (step S11). At the beginning of the installation, the control unit sets a table to be used as a moderate table (step S12). Thereafter, when the user starts using the image forming apparatus 100, the control unit receives a print job (step S13). Then, the control unit determines whether the received print job is a consecutive print job of a predetermined number of sheets (here, 10 sheets) or more (step S14). In the case of the consecutive print job (S14=Yes), the control unit calculates the absolute moisture amount A from the temperature and humidity information in the image forming apparatus 100 at the time of the pre-rotation operation before the start of printing, and measures a primary transfer current I_{A} flowing at that time (step S15). The absolute moisture amount A corresponds to a first absolute moisture amount, and the primary transfer current I_{A} corresponds to a first current value. On the other hand, in a case where the number of consecutive print jobs is less than 10 (that is, in a case where the print job is not a consecutive print job of a predetermined number of sheets or more), Step S14=No, and the moderate table is maintained.

Thereafter, a print operation according to the print job is performed. Then, the control unit calculates the absolute moisture amount B from the temperature and humidity information in the image forming apparatus 100 during the post-rotation operation after the last printing of the consecutive print job, and measures a primary transfer current I_{B} flowing at that time (step S16). The absolute moisture amount B corresponds to a second absolute moisture amount, and the primary transfer current I_{B} corresponds to a second current value. Then, the control unit calculates a current change rate ΔI according to Equation 1 from the absolute moisture amount A, the absolute moisture amount B, the primary transfer current I_{A}, and the primary transfer current I_{B}(step S17). As described above, in this flow, the calculation of the absolute moisture amount and the detection of the current value are performed at the timing of step S15 (first timing) and the timing of step S16 (second timing), respectively.

Subsequently, the control unit determines whether the current change rate ΔI is larger than a first threshold value X, that is, whether ΔI>X (step S18). When the current change rate ΔI>X (S18=Yes), since the current change rate is large, the control unit assumes that the intermediate transfer belt 10 is the ionic belt 10I and sets the ionic table (step S20).

On the other hand, when current change rate ΔI≤X (S18=No), the control unit shifts the process to step S19 and determines whether the current change rate ΔI is smaller than a second threshold smaller than the first threshold, that is, whether ΔI<Y is satisfied. When the current change rate ΔI<Y (S19=Yes), since the current change rate is small, the control unit assumes that the intermediate transfer belt 10 is the electronic belt 10E and sets the electronic table (step S21).

On the other hand, when current change rate ΔI≥Y (S19=No), the current change rate is an intermediate value, that is, equal to or less than the first threshold and equal to or more than the second threshold (Y≤ΔI≤X). In this case, since it is difficult to determine the characteristics of the intermediate transfer belt 10, the control unit holds a state in which the moderate table is set (step S12). Thereafter, the above step is continued until the characteristics of the intermediate transfer belt 10 can be determined. As described above, the control unit acquires environment information (for example, information regarding an absolute moisture amount), and specifies information to be referred to (Tables, Equations, Values, or the like) based on a comparison result between the value and a predetermined threshold. Note that the control unit can also be considered as a determination unit that determines the characteristics (type) of the intermediate transfer belt 10.

In the above description, whether the print job is a consecutive print job of 10 sheets or more is used as a reference for executing the operation of the embodiment, but the disclosure is not limited thereto, and any number of sheets may be used as long as the number of sheets is sufficient to determine the characteristics of the intermediate transfer belt 10. Further, the print job is not necessarily a consecutive print job, and for example, even when intermittent printing continues a plurality of times within a certain time, the operation of the embodiment may be executed to determine the characteristics of the intermediate transfer belt 10. Further, the characteristic discrimination may be performed when the operating time of the image forming apparatus 100 reaches a predetermined time. In addition, the characteristic discrimination may be performed according to a user's instruction using an operation panel or the like.

As described above, it is possible to provide the image forming apparatus 100 that identifies the characteristics of the intermediate transfer belt 10 by a simple means and executes optimal control in accordance with the characteristics of the intermediate transfer belt 10.

### <Effect Confirmation>

In order to identify the characteristics of the intermediate transfer belt 10 of the embodiment and confirm the effect of executing the optimum control according to the identified characteristics, the following test was performed.

For the image forming apparatus 100 of the first embodiment and the image forming apparatus of the following comparative example, the intermediate transfer belt 10 was replaced with an ionic belt 10I. The configuration of first embodiment is as described above. The configuration of the comparative example is a configuration in which the moderate table described in Table 1 is continuously used even if the intermediate transfer belt 10 is replaced. After replacement of the intermediate transfer belt 10, in an environment of a temperature of 23° C./a relative humidity of 50% (an absolute moisture amount of 8.9 g/m³), a temperature of 15° C./a relative humidity of 10% (an absolute moisture amount of 1.1 g/m³), and a temperature of 30° C./a relative humidity of 80% (an absolute moisture amount of 24.0 g/m³), a magenta image density when magenta was printed with a XEROX Business 4200 LETTER size (Xerox, Trade name) as the recording material P was verified. The image density was measured with a Macbeth densitometer (manufacturer: Gretag-Macbeth).

Note that the configuration and operation of the image forming apparatus of the comparative example are substantially the same as the configuration and operation of the image forming apparatus 100 of the embodiment except for tables to be used described above.

Table 2 shows the evaluation results of this test. Table 2 shows the magenta densities (O.D.) of the first embodiment and the comparative example.

TABLE 2

| | 23° C./50% | 15° C./10% | 30° C./80% |
|---|---|---|---|
| Environment | (8.9 g/m³) | (1.1 g/m³) | (24.0 g/m³) |
| First Embodiment | 1.51 | 1.50 | 1.48 |
| Comparative Example 1 | 1.52 | 1.28 | 1.32 |

In the configuration of the comparative example, the image density in an environment of a temperature of 15° C./relative humidity of 10% or an environment of a temperature of 30° C./relative humidity of 80% is lower than the image density in an environment of 23° C./50%. First, the reason the density decreases in an environment of a temperature of 15° C./relative humidity of 10% is that the belt resistance increases due to a change in environmental temperature and humidity, causing the primary transfer current to be slightly insufficient. In addition, the reason the density decreases in an environment with a temperature of 30° C. and a relative humidity of 80% is that the primary transfer current is slightly excessive due to a decrease in belt resistance caused by ion conductive changes resulting from the environmental temperature and humidity. At this time, when a part of the toner transferred onto the intermediate transfer belt 10 at the upstream station passes through the downstream station, discharge occurs, and the polarity of the toner is reversed. As a result, a phenomenon (re-transfer) in which the toner once transferred onto the intermediate transfer belt 10 is transferred to the photosensitive drum 1 again is likely to occur, and the density is lowered.

On the other hand, in the configuration of first embodiment, after the intermediate transfer belt 10 is replaced, the control unit can determine that the ionic belt 10I is installed. Therefore, the control can be performed at an optimum voltage for the resistance variation of the ionic belt 10I in each environment, and there is no large density change in any environment.

As described above, it is possible to provide the image forming apparatus 100 that identifies the characteristics of the intermediate transfer belt 10 by a simple means and executes optimal control in accordance with the identified characteristics.

In the flow of the embodiment, the current change rate is calculated based on the absolute moisture amount and the current value at two timings in the control of the control unit, and this current change rate is used for the control. However, as long as the information on the current value can be acquired at two timings, it is not always necessary to use the absolute moisture amount itself or the current change rate calculated therefrom for the control. That is, the disclosure can be implemented as long as the information on the current value can be acquired at two different timings without detecting the absolute moisture amount itself.

### Modification

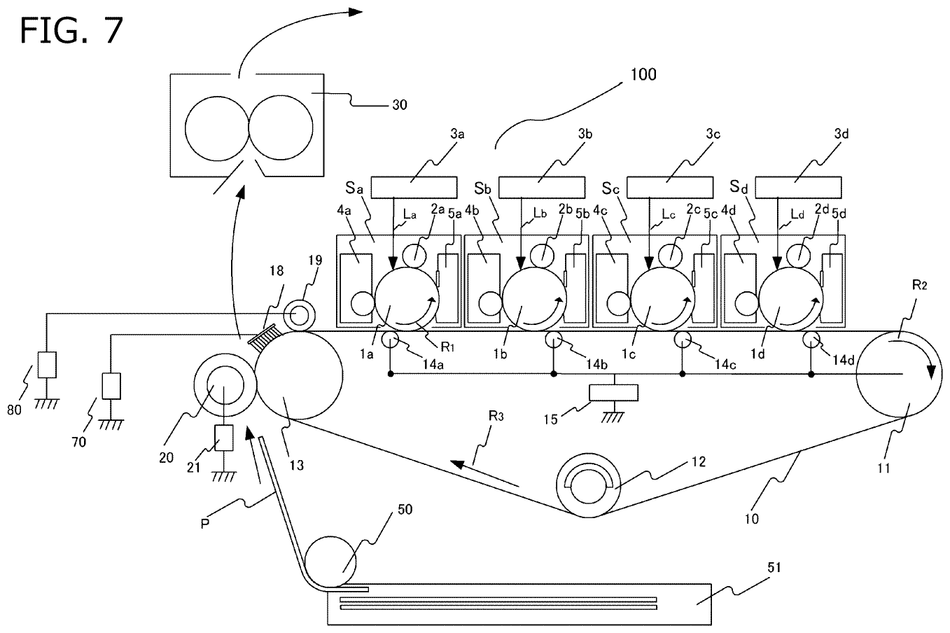

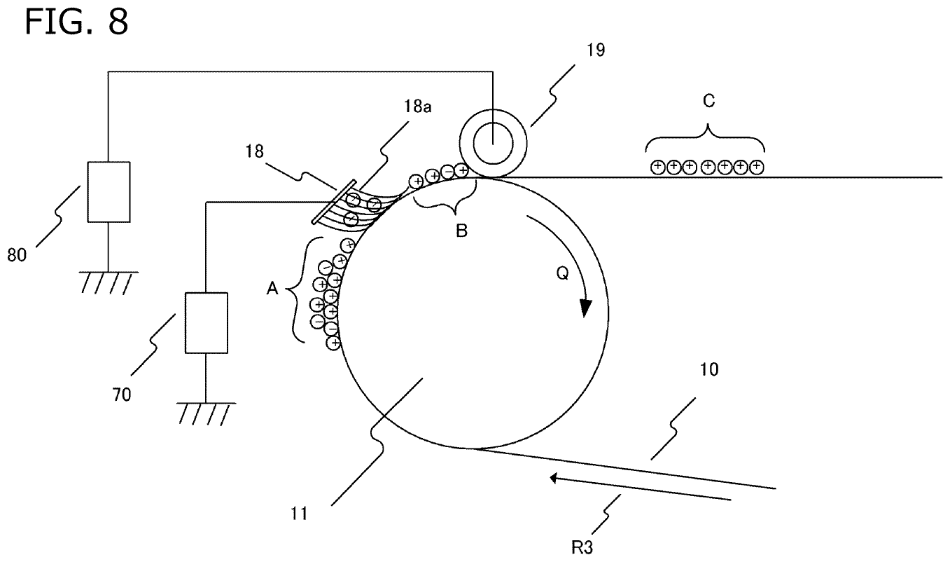

In the embodiment, belt characteristics are determined from a change in the current (primary transfer current) flowing from the primary transfer roller 14, which is a metal roller, to the photosensitive drum 1 via the intermediate transfer belt 10. However, the member is not limited to the primary transfer roller 14 as long as the member is in contact with the intermediate transfer belt 10. For example, a current value of a secondary transfer current flowing from the secondary transfer roller 20 to the ground via the intermediate transfer belt 10 may be used. In addition, a current value flowing through a member in contact with the intermediate transfer belt 10 may be used. For example, when the toner remaining on the intermediate transfer belt 10 after the secondary transfer is electrostatically cleaned, a current value flowing through the cleaning member described below may be used. This will be described in detail with reference to FIGS. 7 and 8.

FIG. 7 is a sectional view of the image forming apparatus 100 in which the cleaning unit including a conductive cleaning brush 18 and a conductive cleaning roller 19 cleans the toner remaining on the intermediate transfer belt 10 after the secondary transfer.

The toner remaining on the intermediate transfer belt 10 after the secondary transfer is charged by the cleaning brush 18 and the cleaning roller 19 arranged at a position facing the driving roller 11. A predetermined voltage is applied to the cleaning brush 18 from a brush charging power supply 70 to charge the secondary transfer residual toner. In the embodiment, since the normal charging polarity of the toner stored in the developing unit 4 is negative, a positive voltage is applied from the brush charging power supply 70 to the cleaning brush 18 to charge the secondary transfer residual toner to the positive polarity.

As the cleaning roller 19, an elastic roller mainly formed of urethane rubber having a volume resistivity of 10⁹ Ω·cm was used. The cleaning roller 19 faces a driving roller via the intermediate transfer belt 10 and is pressurized by a spring (not illustrated) at a total pressure of 9.8 N, and rotates following the rotation of the intermediate transfer belt 10. Further, a positive voltage of 1500 V is applied to the cleaning roller 19 from a roller charging power supply 80, and the secondary transfer residual toner is charged to a positive polarity.

The cleaning brush 18 is made of conductive fibers. Conductive fibers 18a constituting the cleaning brush 18 are mainly made of nylon and have a density of 100 kF/inch². The conductive fiber 18a uses carbon as a conductive agent, and has a resistance value of 1×10⁸ Ω/cm and a fineness of 300 T/60 F per unit length of one conductive fiber 18a.

In the configuration described above, a method for cleaning intermediate transfer belt 10 will be described with reference to FIG. 8.

In the embodiment, as described above, the toner is negatively charged by the developing devices 4a to 4d, then developed on the photosensitive drums 1a to 1d, and primarily transferred to the intermediate transfer belt 10 at the primary transfer unit. Thereafter, an image is formed by secondarily transferring the toner to the recording material P such as paper by the secondary transfer roller 20 to which the positive voltage is applied by the secondary transfer power supply 21.

As illustrated in FIG. 8, the secondary transfer residual toner remaining on the intermediate transfer belt 10 after the secondary transfer is likely to be charged to the positive polarity due to the influence of the positive voltage applied to the secondary transfer roller 20. As a result, the secondary transfer residual toner is in a state in which positive and negative polarities are mixed. Further, due to the influence of the unevenness of the surface of the recording material P, the secondary transfer residual toner locally overlaps a plurality of layers and remains on the intermediate transfer belt 10 (in FIG. 8, reference numeral A is used).

The cleaning brush 18 positioned on the upstream side with respect to a rotation direction Q of the intermediate transfer belt 10 is fixedly arranged with respect to the intermediate transfer belt 10 that rotationally moves, and is arranged with a predetermined entry amount with respect to the intermediate transfer belt 10. The entry amount indicates a difference between a natural length, which is a length in a state where the cleaning brush 18 is not in contact with anything, and a length when the cleaning brush is in contact with the intermediate transfer belt 10.

The cleaning brush 18 is supported in the apparatus without rotating during the movement of the intermediate transfer belt 10. Therefore, when the secondary transfer residual toner passes through a charging unit formed by the cleaning brush 18 and the intermediate transfer belt 10, the secondary transfer residual toner deposited in a plurality of layers on the intermediate transfer belt 10 is mechanically leveled to substantially one layer by a peripheral speed difference from the cleaning brush 18 (in FIG. 8, reference numeral B is used).

In addition, by applying a positive voltage from the brush charging power supply 70 to the cleaning brush 18 to perform constant current control, when the secondary transfer residual toner passes through the charging unit, the secondary transfer residual toner is charged to a positive polarity that is opposite to the toner polarity at the time of development. A part of the negative polarity toner that has not been charged to the positive polarity is collected by the cleaning brush 18. Thereafter, the secondary transfer residual toner that has passed through the cleaning brush 18 moves in a moving direction of the intermediate transfer belt 10 and reaches the cleaning roller 19. A positive voltage (+1500 V in the embodiment) is applied to the cleaning roller 19 by the roller charging power supply 80. The secondary transfer residual toner passing through the cleaning brush 18 and charged to the positive polarity is further charged when passing through the cleaning roller 19 (in FIG. 8, reference numeral C is used).

The secondary transfer residual toner to which the optimum charge (positive polarity in this case) is applied moves to the photosensitive drum 1a charged to the negative polarity in the primary transfer unit. Then, the secondary transfer residual toner moved from the intermediate transfer belt 10 to the photosensitive drum 1a is recovered to the cleaning device 5a arranged on the photosensitive drum 1a.

The timing at which the secondary transfer residual toner charged to the positive polarity is moved from the intermediate transfer belt 10 to the photosensitive drum 1a may be performed at the same time as the timing (at the same time as the transfer) at which the toner image is primarily transferred from the photosensitive drum 1a to the intermediate transfer belt 10, or may be performed separately.

In the embodiment, the cleaning roller 19 is disposed on the downstream side of the cleaning brush 18 in the rotation direction of the intermediate transfer belt 10. An object thereof is to make the charge amount after passing through the charging unit more uniform. Therefore, the secondary transfer residual toner may be charged only with the cleaning brush 18 as long as the charge amount of the secondary transfer residual toner can be within a predetermined range without the cleaning roller 19.

In the configuration as described above, the belt characteristic can be determined by the value of the current flowing from the cleaning brush 18 or the cleaning roller 19 to the ground via the intermediate transfer belt 10. A specific belt characteristic detection method, detection timing, a detection threshold, and the like may be substantially the same as those of the detection by the primary transfer roller current described in the first embodiment, and the threshold and the like may be appropriately changed. Note that the member that comes into contact with the intermediate transfer belt 10 to detect the current, in one embodiment, is a member having a low resistance value with respect to the intermediate transfer belt 10 and a small change in resistance value with respect to a change in temperature and humidity, such as the metal roller described above.

### <Other Configurations: Reflection in Optimal Control>

In the above embodiment, the control table used for the control of the primary transfer has been described as an example of a control target using the determination result. However, the control target is not limited thereto, and may be another member that operates when a voltage is applied from a power supply unit. For example, the control of the secondary transfer voltage, the control voltage of the process cartridge, and the potential control may be changed. With respect to the voltage and potential control of the process cartridge, for example, instead of changing the primary transfer voltage, the charging voltage, the exposure intensity, the weak exposure intensity, and the like may be changed to change the photosensitive drum potential, or the developing voltage and the like may be changed to perform optimal primary transfer control. When the intermediate transfer belt 10 is electrostatically cleaned, the control of the cleaning voltage may be changed in accordance with the belt characteristics.

In the embodiment, an ionic table, an electronic table, and a moderate table are provided. However, the control method is not limited to the table change. For example, graphs or equations according to the type of belt may be used. In addition, the control may be performed with an optimum setting value by changing an offset amount or a coefficient with respect to a certain reference control value.

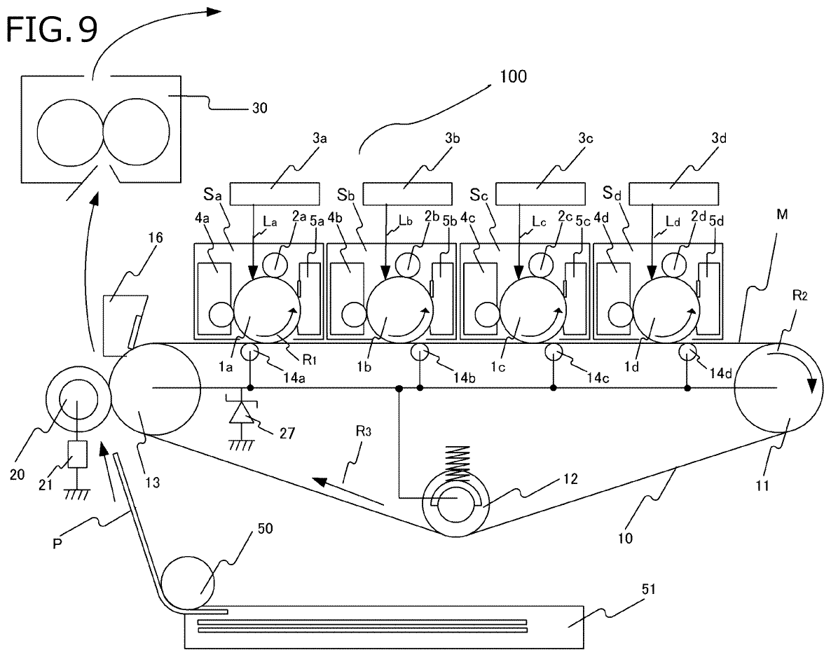

In addition, the disclosure can also be applied to a configuration in which the primary transfer power supply 15 (high-voltage power supply) is not provided, and the secondary transfer power supply 21 is used as a common transfer power supply for primary transfer and secondary transfer to achieve downsizing and cost reduction of the apparatus. Specifically, as illustrated in FIG. 9, the secondary transfer opposite roller 13, the driving roller 11, and the stretching roller 12 as a tension roller are grounded via a Zener diode 27 as a voltage maintaining element. A primary transfer roller, which is a contact member in contact with the inner peripheral surface of the intermediate transfer belt 10, is disposed at a position between the secondary transfer opposite roller 13 and the driving roller 11. At this time, the absolute value of the Zener voltage of the Zener diode 27 becomes the primary transfer voltage, and the primary transfer voltage becomes a fixed value.

In such a configuration in which the primary transfer voltage is fixed, the control is performed in accordance with the electrical characteristics of the intermediate transfer belt 10 by means other than the primary transfer voltage. A difference in the amount of discharge in the primary transfer unit occurs due to a difference in the electrical characteristics of the intermediate transfer belt 10. Therefore, the amount of re-transfer described above also differs. In order to make the amount of re-transfer due to the difference in the amount of discharge constant regardless of the characteristics of the intermediate transfer belt 10, the primary transfer may be optimally controlled by the potential of the photosensitive drum 1. Alternatively, the calculation of the life span of the waste toner container of the photosensitive drum 1 may be changed because the amount of re-transfer also changes depending on the difference in the amount of discharge, or the calculation of the life span of the photosensitive drum 1 may be changed because the degree of wear of the surface of the photosensitive drum 1 changes depending on the difference in the amount of discharge.

In addition, by changing voltage conditions to a regulating member that regulates the toner layer on the developing roller 22 in the developing unit 4 (not illustrated), a supply roller that supplies toner onto the developing roller, and the like, and adjusting the toner charge amount and the toner amount to be developed, a change may be made so that the retransfer amount is optimized regardless of the characteristics of the intermediate transfer belt 10. Although the Zener diode 27 is used as a voltage stabilizing element, another voltage stabilizing element may be used as long as the element can obtain the same effect. For example, a varistor or other element may be used.

Not limited to the electrical characteristics, for example, since the optical density of the electronic belt 10E using a large amount of carbon black as a conductive material becomes high, the control in the density adjustment operation may be changed between the ionic control and the electronic control.

### <Other Configuration: Method of Determining Belt Resistance Characteristics>

In the embodiment, the belt characteristics were determined using the change rate ΔI of the primary transfer current value with respect to a change in temperature and humidity of the environment. However, the absolute value of the change in the primary transfer current value may be used instead of the change rate. This is because, since the electronic belt 10E has a small change in current value, it can be determined as the ionic belt 10I if a change of a certain current value or more can be detected. In this case, the absolute value of the change is compared with a predetermined threshold value, and if there is a change equal to or more than the threshold value, it is determined as the ionic belt 10I, and if it is less than the threshold value, it is determined as the electronic belt 10E. Also in this case, two threshold values may be provided, and in the case of an intermediate value, determination may be reserved and a moderate table may be used.

In the above embodiment, the accuracy of the determination of the belt characteristic is improved by using the moderate table, but it is not always necessary to provide the moderate table. Specifically, the threshold value of ΔI may be set to only X, and the ionic table may be used if ΔI>X, and the electronic table may be used if ΔI≤X. In this case, X may be the same value as X (first threshold) used in the above embodiment, but is more preferably a value between X and Y. In this case, X in the present modification may be considered as a third threshold. With this method, the time required for determination can be shortened, so that an appropriate control value can be used early. Note that, in one embodiment, in a case of adopting a method using a single threshold in this manner, it is to set a threshold with as high accuracy as possible based on experiments, results, and the like.

In one embodiment, although only one threshold X and one threshold Y for the absolute moisture amount are provided in the embodiment, the disclosure is not limited thereto, and a plurality of thresholds X and Y may be provided. Here, as illustrated in FIG. 1A, in the ionic belt 10I, the amount of change in the current value is different between an environment with a small absolute moisture amount and an environment with a large absolute moisture amount. Therefore, in order to more accurately determine the belt characteristics, the thresholds X and Y may be changed for each absolute moisture amount. For example, as shown in Table 3, the threshold values X and Y in the environment with a small absolute moisture amount and the threshold values X and Y in the environment with a large absolute moisture amount may be used separately.

TABLE 3

| Absolute | Less than | Equal to or more |
|---|---|---|
| moisture amount | 10.0 g/m³ | than 10.0 g/m³ |
| X | 0.3 μA/g/m³ | 0.2 μA/g/m³ |
| Y | 0.05 μA/g/m³ | 0.05 μA/g/m³ |

In addition, although the current change with respect to the absolute moisture amount is used in the embodiment, the disclosure is not limited to the above embodiment, and any one of temperature and humidity may be used as the environmental information. In this case, a table or the like is created based on a current change with respect to a difference in the temperature or the humidity.

In the embodiment, it is assumed that the intermediate transfer belt 10 having greatly different electrical characteristics is installed for easy understanding of the description, but the disclosure is not limited thereto. For the intermediate transfer belt 10 having hybrid characteristics to which both a conductive agent such as carbon and an ionic conductive agent are added, a difference in the characteristics may be detected and reflected in optimal control. Alternatively, the belt characteristic may be detected in order to reflect the individual difference of the intermediate transfer belt 10 in the control with respect to the intermediate transfer belt 10 having the same conductive form.

As described above, it is possible to provide the image forming apparatus 100 that identifies the characteristics of the intermediate transfer belt 10 by a simple means and executes optimal control in accordance with the characteristics of the intermediate transfer belt 10.

### Second Embodiment

In the first embodiment, the electrical characteristics of the intermediate transfer belt 10 were determined using the amounts of change in various current values in two different absolute moisture amounts, and optimal control in accordance with the belt characteristics was performed based on the results. In the second embodiment, the electrical characteristics of the intermediate transfer belt 10 are determined using the voltage characteristics in various current values in two different absolute moisture amounts, and optimal control in accordance with the belt characteristics is performed based on the results. The same configurations, operations, and effects as those of the first embodiment are denoted by the same reference numerals, and description thereof is omitted.

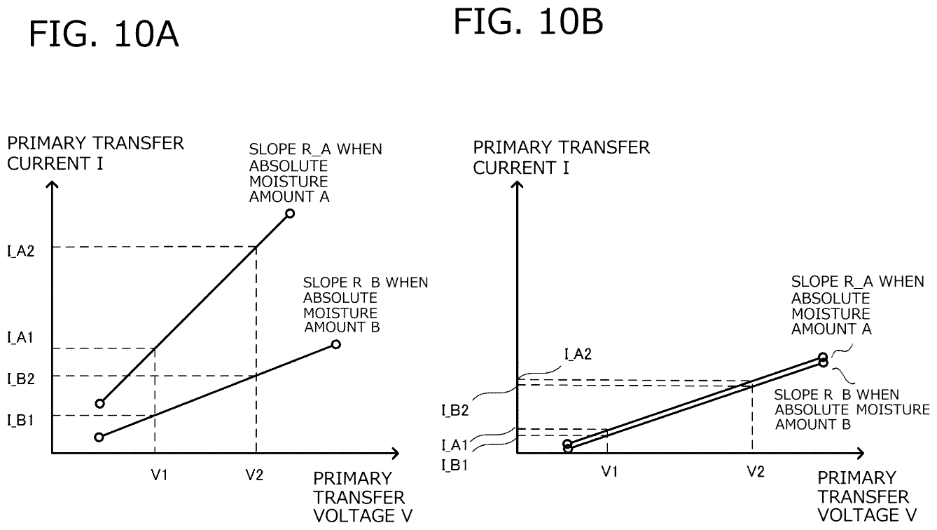

Also in the embodiment, as in the first embodiment, a primary transfer current value (hereinafter, simply referred to as a current value) is used as an example. FIGS. 10A and 10B are graphs plotting the voltage dependence of the current values of the ionic belt 10I and the electronic belt 10E at two different absolute moisture amounts (1.0 g/m³ and 24.0 g/m³ in the embodiment). FIG. 10A is a graph for the ionic belt 10I, and FIG. 10B is a graph for the electronic belt 10E.

In the case of the electronic belt 10E, the resistance value fluctuates less with respect to a change in temperature and humidity of the environment. Therefore, as illustrated in FIG. 10B, the amount of change in current at different voltages hardly changes even when the absolute moisture amount of the environment is greatly different. This can be seen from the comparison between a slope R_A at the absolute moisture amount A and a slope R_B at the absolute moisture amount B in FIG. 10B. In the drawing, from a current value I_A1 measured by applying a voltage V1 (first voltage) at the absolute moisture amount A and a current value I_A2 measured by applying a voltage V2 (second voltage) at the same absolute moisture amount A, the slope R_A at the absolute moisture amount A is obtained. Similarly, from a current value I_B1 measured by applying a voltage V1 at the absolute moisture amount B and a current value I_B2 measured by applying a voltage V2 at the same absolute moisture amount B, the slope R_B at the absolute moisture amount B is obtained. The slope characteristic here indicates the slope of the voltage-current characteristics.

On the other hand, in the case of the ionic belt 10I, the change in the resistance value is large with respect to the change in the temperature and humidity of the environment. Therefore, as illustrated in FIG. 10A, the amount of change in the current at different voltages greatly changes when the absolute moisture amount in the environment changes. This can be seen from the comparison between a slope R_A at the absolute moisture amount A and a slope R_B at the absolute moisture amount B in FIG. 10A. Since the mechanism of the change in the resistance value due to the difference in the absolute moisture amount is as described in the first embodiment, the description thereof is omitted.

In the embodiment, the characteristics of the intermediate transfer belt 10 are determined from the difference in the characteristics of the current value with respect to the voltage in the environment in which the temperature and humidity of the environment, that is, the absolute moisture amount of the intermediate transfer belt 10 is different. Specifically, the voltage characteristic of the current value, that is, a change in the current value in a range of voltages V1 and V2, is measured at two timings at which the detected absolute moisture amount is different, and the change rate ΔR of the current value is calculated from the voltage characteristic as shown in Equation (2). That is, the change rate of the voltage-current characteristic is calculated.

$$Δ R = {R}_{A} - {R}_{B} \qquad ( Equation 2 )$$

Here, A and B are absolute moisture amounts detected by the image forming apparatus, respectively, and A≠B [g/m³] is established. That is, it is an absolute moisture amount measured at another timing. R_{A} is a change rate of a current value in the absolute moisture amount A [g/m³] with respect to a voltage, and is specifically represented by R_{A}=(I_{A2}−I_{A1})/(V1−V2) [μA/V]. Similarly, R_{B} is a change rate of the current value at the absolute moisture amount B [g/m³] with respect to the voltage, and is represented by R_{B}=(I_{B1}−I_{B2})/(V1−V2) [μA/V]. When ΔR is negative, it is considered as an absolute value.

In the embodiment, a threshold X2 and a threshold Y2 (>X2) are stored in the RAM 152 in advance with respect to the change rate ΔR of the current value. The threshold X2 is considered to be a fourth threshold, and the threshold Y2 is considered to be a fifth threshold smaller than the fourth threshold. Here, if the change rate ΔR>X2 obtained above is satisfied, since the change rate is large, it can be determined that the intermediate transfer belt 10 installed in the image forming apparatus 100 is the ionic belt 10I. On the other hand, if ΔR<Y2 is satisfied, since the change rate is small, it can be determined that the intermediate transfer belt 10 installed in the image forming apparatus 100 is the electronic belt 10E.

In the embodiment, in order to reliably determine the belt characteristics, determination is reserved in the intermediate region where Y2≤ΔR≤X2. That is, when the change in the change rate ΔR as the detection result is incomplete, the electrical characteristics are not determined in order to prevent erroneous detection of the electrical characteristics of the intermediate transfer belt 10.

When the values of the absolute moisture amounts A and B are too close to each other, the change rate ΔR becomes almost 0 regardless of the characteristics of the intermediate transfer belt 10, and erroneous detection may occur. Therefore, in one embodiment, ΔR is calculated when the absolute moisture amounts A and B are different to some extent (for example, about 2.0 g/m³ or more).

In the embodiment, transfer control is performed as follows according to the value of ΔR.
If ΔR>X2, use control table for ionic belt
If ΔR<Y2, use of control table for electronic belt
If Y2≤ΔR≤X2, belt characteristics are not able to be determined, and therefore a moderate control table is used.

As described above, in a case of Y2≤ΔR≤X2, determination on which belt has which characteristics is reserved and a moderate control table is used. In this case, the change rate ΔR may be calculated again at an optional timing (for example, after printing a predetermined number of sheets or after elapse of a predetermined time) to detect the characteristics of the intermediate transfer belt 10. On the other hand, in the case of ΔR>X2 and in the case of ΔR<Y2, the characteristics of the installed intermediate transfer belt 10 can be determined. Therefore, the calculation of ΔR and the detection of the intermediate transfer belt characteristic may not be performed again.

In the embodiment, the threshold values X2 and Y2 are set to X2=0.2 μA/V and Y2=0.1 μA/V, respectively.

The determination timing of the embodiment is similar to the timing described in the first embodiment. In addition, since the reflection to the transfer control and the like after the electrical characteristics of the intermediate transfer belt 10 can be determined are also similar to those in first embodiment, the description thereof will be omitted. Also in the embodiment, the determination may be made earlier with one threshold (sixth threshold).

In addition, the current to be detected does not need to be a primary transfer current as in the first embodiment, and may be a secondary transfer current or a current flowing from a cleaning roller or a cleaning brush to the ground via the intermediate transfer belt 10. In addition, in a case where the electrical characteristics and the optical characteristics of the intermediate transfer belt 10 can be determined, they may be reflected in other control as in the first embodiment.

In the embodiment, the belt characteristics are determined using the difference of the change rate (slope) of the primary transfer current value with respect to the voltage in environments with different absolute moisture amounts, but the disclosure is not limited thereto. For example, a change rate of the slope with respect to the absolute moisture amount may be used. In the embodiment, the current change with respect to the absolute moisture amount is used, but the disclosure is not limited thereto, and the current change with respect to one of the temperature and the humidity may be used.

In the embodiment, for easy understanding of the description, two types of intermediate transfer belts 10 having different conductive forms, that is, the electronic belt 10E and the ionic belt 10I, are determined, but the disclosure is not limited thereto. For example, even in the intermediate transfer belt 10 having the same conductive form, the characteristics may be different to an extent that can be discriminated by the method of the disclosure depending on a difference in material and design. In that case, the difference in the characteristics may be detected by the method of the disclosure and reflected in the optimal control.

As described above, it is possible to provide the image forming apparatus 100 that identifies the characteristics of the intermediate transfer belt 10 by a simple means and executes optimal control in accordance with the characteristics of the intermediate transfer belt 10.

According to the disclosure, it is possible to provide a technique for easily identifying characteristics of an intermediate transfer belt in an image forming apparatus.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-035173, filed Mar. 6, 2025, which is hereby incorporated by reference herein in its entirety.

What is claimed is:

1. An apparatus capable of executing an operation of forming an image on a recording material, the apparatus comprising:
a photosensitive drum;
a developing unit that forms a toner image by supplying toner to the electrostatic latent image formed on a surface of the photosensitive drum;
a transfer member to which the toner image is transferred from the photosensitive drum;
a power supply unit that supplies a current to the transfer member;
a current detection unit that detects a current value supplied by the power supply unit;
an information detection unit that acquires information on a moisture amount in an environment in which the apparatus is installed, based on information on temperature and humidity in the environment; and
a control unit;
wherein
the information detection unit acquires a first moisture amount at a first timing and acquires a second moisture amount at a second timing,
the current detection unit detects a first current value at the first timing and detects a second current value at the second timing, and
the control unit controls a transfer condition in the operation based on the first moisture amount, the second moisture amount, the first current value, and the second current value.

2. The apparatus according to claim 1, wherein
the control unit controls the transfer condition based on a current change rate indicating a degree of change in the current value with respect to change in the moisture amount between the first timing and the second timing.

3. The apparatus according to claim 2, wherein
the control unit controls the transfer condition by changing a transfer voltage when the power supply unit supplies a current to the transfer member according to a result of comparing the current change rate with a predetermined threshold value.

4. The apparatus according to claim 3, further comprising:
a storage unit that stores a table indicating control of the transfer voltage,
wherein the control unit refers to the table different between a case where the current change rate is larger than the predetermined threshold and a case where the current change rate is equal to or less than the predetermined threshold.

5. The apparatus according to claim 4, wherein
the table holds information related to control of the transfer voltage according to the moisture amount in the environment.

6. The apparatus according to claim 3, wherein
the control unit performs control such that a degree of change in the transfer voltage in accordance with the change in the moisture amount becomes larger as the current change rate is larger, and a degree of change in the transfer voltage in accordance with the change in the moisture amount becomes smaller as the current change rate is smaller.

7. The apparatus according to claim 4, wherein
the control unit performs control such that a degree of change in the transfer voltage in accordance with the change in the moisture amount becomes larger as the current change rate is larger, and a degree of change in the transfer voltage in accordance with the change in the moisture amount becomes smaller as the current change rate is smaller.

8. The apparatus according to claim 1, wherein
the power supply unit applies a first voltage and a second voltage,
the current detection unit detects the current value for each of the first voltage and the second voltage at each of the first timing and the second timing.

9. The apparatus according to claim 8, wherein
the control unit controls the transfer condition based on a change rate of a voltage-current characteristic calculated from the current value with respect to the first voltage and the current value with respect to the second voltage at each of the first timing and the second timing.

10. The apparatus according to claim 8, wherein
the first timing is different from the second timing, and
the first voltage is different from the second voltage.

11. The apparatus according to claim 1, wherein
the current detection unit detects one of a current value flowing to a primary transfer roller that performs primary transfer in which the toner image is transferred from the photosensitive drum to the transfer member, a current value flowing to a secondary transfer roller that performs secondary transfer in which the toner image is transferred from the transfer member to a recording material, and a current value flowing to a cleaning unit that electrostatically cleans toner remaining on the transfer member.

12. The apparatus according to claim 1, wherein the first timing is different from the second timing.
